(19) United States
(12) Patent Application Publication
(10) Pub. No.: US 2018/0215132 A1
(43) Pub. Date: Aug. 2, 2018

(54) GARMENT OR SUBSTRATE AND SYSTEMS AND METHODS FOR CREATION THEREOF

(71) Applicant: THE NORTH FACE APPAREL CORP., Wilmington, DE (US)

(72) Inventors: Alexander Dardinski, Newburyport, MA (US); Emily Alati, Portsmouth, NH (US); John Ly, Alameda, CA (US); Ryan Taylor Massey, Alameda, CA (US)

(73) Assignee: THE NORTH FACE APPAREL CORP., Wilmington, DE (US)

(21) Appl. No.: 15/879,542

(22) Filed: Jan. 25, 2018

Related U.S. Application Data
(60) Provisional application No. 62/450,952, filed on Jan. 26, 2017.

(51) Int. Cl. B32B 37/14; A41D 27/00; A41H 42/00; B32B 9/04; B32B 37/24; B82Y 40/00; D01D 5/00; D01D 5/08

(52) U.S. Cl. CPC B32B 37/144; A41D 27/00; A41H 42/00; B32B 9/047; B32B 37/24; B82Y 40/00; B32B 2437/00; D01D 5/08; A41D 2400/10; A41D 2400/22; A41D 2400/62; A41D 2500/00; B32B 2309/68; D01D 5/0007

(57) ABSTRACT

Multilayer substrates are provided that do not require use of an attachment mechanism to combine the different layers of material. Further, the systems and method for creation thereof is also provide. Additionally, structured garments with very few or no seams are provided herein. The systems and method for creation thereof is also provided. More specifically, sprayable nanofibers are utilized to create the above-described multilayered fabrics and structured garments. Accordingly, the provided systems and method are more efficient and more cost effective than previously utilized systems and methods for creating multilayer or structured substrates or garments that required the use of adhesive mechanisms and/or several seams.

### CROSS-REFERENCE TO RELATED APPLICATIONS

This application claims priority to U.S. Provisional Patent Application No. 62/450,952, filed Jan. 26, 2017, the disclosure of which is hereby incorporated by reference herein in its entirety.

### INTRODUCTION

Clothing and material manufacturers are always looking for ways to improve their materials and/or garments. For example, manufacturers may try to select one or more materials with specific properties to achieve a garment with specific insulation, wicking, and/or breathability properties.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to a substrate with very few or no seams or a multilayered substrate that does not utilized any attachment mechanism and the systems and methods for creation thereof. More specifically, sprayable nanofibers are utilized to create fabrics that adhere to other fabrics and to create garments that have no or very few seams. Accordingly, the provided systems and methods are more efficient and more cost effective than previously utilized systems and methods for creating multilayered or structured substrates or garments that required the use of attachment mechanisms and/or several seams.

One aspect of the disclosure is directed to a method for creating a garment. The method includes:
conveying a base into a first processing unit;
applying at least one type of sprayable nanofibers to the base to form a first nanofiber fabric on the base; and
conveying the first nanofiber fabric out of the first processing unit.

In another aspect, the disclosure is directed to a garment. The garment includes a first layer and a second layer. The first layer is formed utilizing first nanosprayed fibers. The second layer is attached to the first layer. The second layer is formed utilizing second nanosprayed fibers. There are no seams in the garment. Further, an attachment mechanism is not utilized to attach the first layer to the second layer. Additionally, the first layer has a different structure than the second layer.

In yet another aspect of the disclosure, a processing system for producing a multilayer substrate is provided. The processing system includes an application system and at least one nanofiber spinneret in the application system. The application system is an automated system for conveying a base from an initial position through the application system to an end position. The at least one nanofiber spinneret sprays nanofibers of at least one type of material on to the base located in the application system to form a nonwoven fabric on the base.

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

These and other features and advantages will be apparent from a reading of the following detailed description and a review of the associated drawings. It is to be understood that both the foregoing general description and the following detailed description are illustrative only and are not restrictive of the claims

### BRIEF DESCRIPTION OF THE DRAWINGS

Non-limiting and non-exhaustive examples or aspects are described with reference to the following Figures. The patent or application file contains at least one drawing executed in color. Copies of this patent or patent application publication with color drawings will be provided by the Office upon request and payment of the necessary fee.

FIG. 1 is a schematic diagram illustrating a spinneret spraying spun nanofibers onto a base, in accordance with an aspect of the disclosure.

FIG. 2 is a schematic diagram illustrating a multiple pass application system for the processing system, in accordance with an aspect of the disclosure.

FIG. 3 is a schematic diagram illustrating a single pass application system for the processing system, in accordance with an aspect of the disclosure.

FIG. 4 is a schematic flow diagram illustrating different multilayer substrates created from processing system, in accordance with an aspect of the disclosure.

FIG. 5 is a schematic diagram illustrating a processing unit with a custom roll surface, in accordance with an aspect of the disclosure.

FIG. 6 are pictures illustrating different structures of various sizes that may be utilized in the custom roll surface shown in FIG. 5, in accordance with an aspect of the disclosure.

FIG. 7 is a schematic diagram illustrating different multilayer substrates with layer structures created by utilizing a custom roll surface, in accordance with an aspect of the disclosure.

FIG. 8 is a schematic diagram illustrating a processing unit with a custom filter and vacuum, in accordance with an aspect of the disclosure.

FIG. 9 is a schematic diagram illustrating a conventional filter and a custom filter, in accordance with an aspect of the disclosure.

FIG. 10 is a schematic diagram illustrating a processing unit for spaying nanofibers onto a partial three-dimensional mold, in accordance with an aspect of the disclosure.

FIG. 11 is a schematic diagram illustrating a spinneret, different three-dimensional molds, and a seamless multilayered garment, in accordance with an aspect of the disclosure.

FIG. 12 is a schematic diagram illustrating a processing unit for spaying nanofibers onto a three-dimensional mold with a custom filter and vacuum, in accordance with an aspect of the disclosure.

FIG. 13 is a schematic diagram illustrating different nanofiber structures created from the same material by adjusting the application speed, application temperature, and extrusion die utilized by a spinneret in a processing unit, in accordance with an aspect of the disclosure.

FIG. 14 is a flow diagram illustrating a method 400 for creating a substrate or garment, in accordance with an aspect of the disclosure.

### DETAILED DESCRIPTION

In the following detailed description, references are made to the accompanying drawings that form a part hereof, and in which are shown by way of illustrations specific aspects or examples. These aspects or examples may be combined, other aspects or examples may be utilized, and structural changes may be made without departing from the spirit or scope of the present disclosure. The following detailed description is therefore not to be taken in a limiting sense.

To create garments with desired properties, often times several different types and/or layers of materials are combined to make the finish product. The different materials in a substrate or garment may each have different properties. For example, outerwear may need to be warm and waterproof. As such, an insulating material may be combined with a waterproof material to create an outerwear garment with these desired properties. Garments often include two or more different materials to achieve desired properties. However, each different layer has to be attached to each other. For example, the layers may be combined utilizing lamination, adhesive, sewing, etc. However, the attachment mechanism typically interferes or affects the properties of the material in the layers of the garment. For example, an adhesive may interfere with the breathability of a garment. Further, the adding of each new layer slows down production of the garment. For example, each new layer often requires that a garment be transferred from one production line to another and may even require a transfer to an entirely different manufacturing facility. As such, each added layer to a garment impedes the properties of the material in the layers due to the use of an attachment mechanism and/or increases production time and costs.

Most garments require one or more pieces to be sewn or attached together to form a garment. Further, a desired structure of the finished garment must be carefully constructed and provided as the different pieces of the garment are combined. As such, most garments include multiple seams that have to be aligned, structured, and attached to finish production of the garment. These specific alignments, structure, and attachments also increase production time and costs.

Currently, there is no system or method for forming structured garments with limited or no seams. There is also no system or method that can combine different layers of material into a substrate or garment that does not require use of an adhesive mechanism. Further, there is no system or method that can combined different layers of material into a substrate or garment that can be performed by a single automated assembly process.

Therefore, the systems and methods disclosed herein create multilayer substrates or garments that do not require use of an attachment mechanism to combine the different layers of material. The different layers may include different types of material. Further, the systems and methods disclosed herein can create multilayer or structured substrates or garments utilizing an automated or semi-automated assembly process. The systems and methods disclosed herein create multilayer substrates or garments by applying multiple layers of sprayable nanofiber material to each other or by applying a sprayable nanofiber material to another fabric Further, the systems and methods as described herein can form or create structured garments with very few or no seams. Accordingly, the systems and method as described herein are more efficient and cost effective than previously utilized systems and methods for creating multilayer or structured substrates or garments that required the use of adhesive mechanisms and/or several seams. Further, the systems and method as described herein create a multilayer substrate or garment with more effective material properties than previously utilized systems and methods for creating multilayer substrates or garments that required the use of adhesive mechanisms that interfere with the properties of the materials in the layers.

Referring now to the drawings, in which like numerals represent like elements through the several figures, various aspects of the present disclosure will be described.

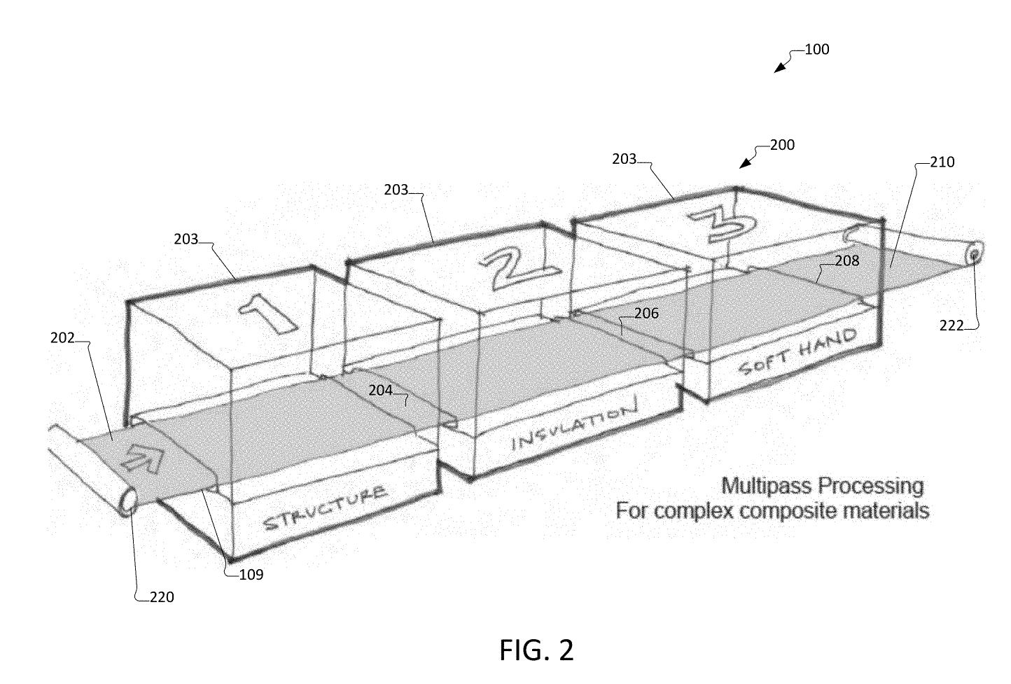

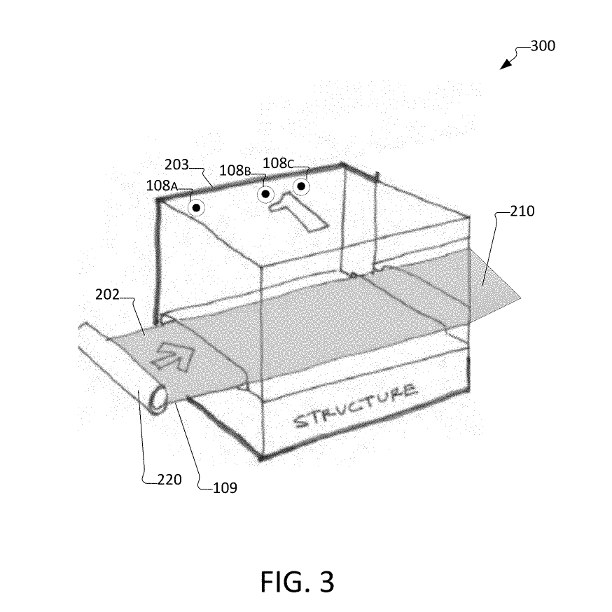

Clothing and material manufactures have just started exploring the benefits of nanotechnology and its applications to the generation of new garments and materials. FIGS. 2 and 3 illustrate different embodiments of a processing system 100 for producing substrates or garments 210, such as multilayered substrates and/or garments.

A substrate 210 as utilized herein refers to a fabric created from nanosprayed material or a garment created from a fabric of nanosprayed material. A fabric as utilized herein refers to any woven, nonwoven, or compound material that is suitable for garment production. A woven fabric as utilized herein refers to any material that has been created from weaving or knitting. A nonwoven fabric as utilized herein refers to any sheet or web structure that has been created from mechanically, thermally, and/or chemically entangling fibers or filaments. The garment may be a pair of pants, a shirt, a skirt, a jacket, a pair of shorts, a vest, a hat, a pair of gloves, a dress, a pair of leggings, a pair of capris, a bra, a piece of underwear, a piece of swim wear, a pair of shoes, etc. This list is exemplary only and is not meant to be limiting. Any item of clothing or outerwear that may be worn by a person or animal may be formed from the garment or substrate from processing system 100.

The processing system 100 includes one or more processing units 203. A processing system 100 with a single processing unit 203 is a single pass application system 300 and a processing system 100 with multiple processing units 203 is a multiple pass application system 200. In some aspects, the processing unit 203 is configured to form a multilayer substrate 210. The processing system 100 may also include a full or partially automated system 109 for conveying a base 202 from an initial position through the one or more processing units 203. Each processing unit 203 includes one or more nanofiber spinnerets 108.

In additional aspects, the processing system 100 includes one or more embossing units. The embossing units utilize a sonic and/or heat patterned roller to emboss a created nanospun fabric with a desired shape and/or pattern.

The base 202 may be a material, a woven fabric, nonwoven fabric, a mold, a filter, and/or another object intended to receive sprayable nanofiber material. The automated system 109 or the partially automated system may be configured to convey the substrate 210 created by the one or more processing units 203 to an end position. In some aspects, the created substrate 210 includes the base. In other aspects, the created substrate 210 does not include the base. In some aspects, the initial position is on a start roll 220 and the end position is rolled onto an end roll 222.

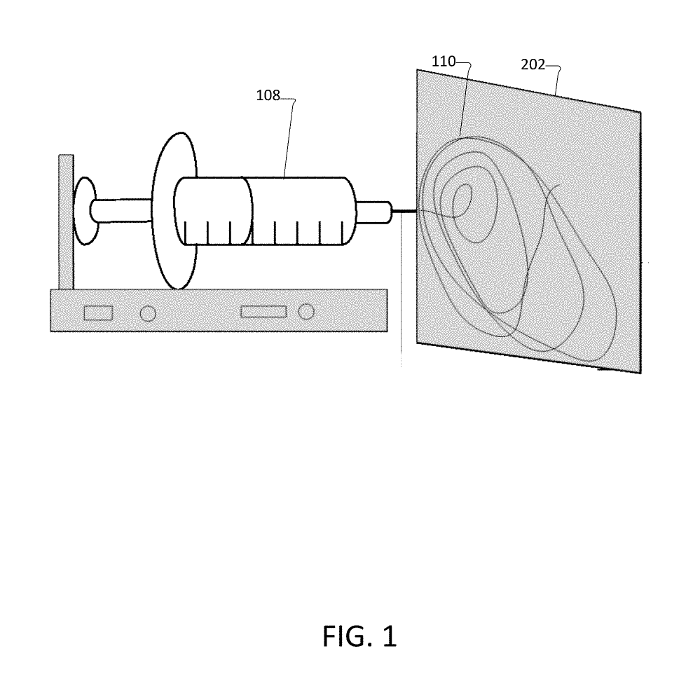

The nanofibers 110 are created and sprayed utilizing spun nanofiber technology by the processing system 100. For example, the spun nanofiber technology may include force spinning, electrospinning, melt electrospinning, centrifugal melt electrospinning, island-in-the-sea extrusion, or hot air assisted melt electrospinning. FIG. 1 illustrates an example of a spinneret 108 for spraying nanofibers 110 onto a base 202 for creating a material made of the sprayed nanofibers on the base 202.

In some aspects, the processing system 100 creates multilayer substrate 210. The multilayer substrate 210 formed by processing system 100 does not utilize any attachment mechanism to combine or join the different types of materials together. In some aspects, the multilayer substrate 210 is created by utilizing different types of sprayable nanofiber materials in succession. In other aspects, where the base layer 102 is a fabric or material, the multilayer substrate 210 is created by spraying the nanofiber material onto the base fabric layer. In these aspects, the properties of the base fabric can be enhanced or improved by the sprayed nanofiber fabric layer. For example, a wool fabric may be sprayed with a soft hand feel nanofiber fabric layer to prevent the wool garment from being itchy or uncomfortable to the touch. In another example, an insulating material may be combined with a sprayed nanofiber fabric that is breathable and waterproof or water resistance to provide water protection. While an attachment mechanism is not necessary to bond the two different materials together, in some aspects, pressure, vacuum, or mechanical structure manipulation may be utilized to increase the adhesion between the two different layers of material in the multilayer substrate 210.

FIG. 2 illustrates an example of a multiple pass application system 200 for processing system 100 for automated creation of a substrate or garment 210. The multiple pass application system 200 is capable forming a multilayer substrate utilizing a plurality of processing units 203. In this example, the multiple pass application system 200 includes three different processing units 203 for adding three different types of fabric 204, 206, and 208 to a base 202 as the base 202 rolls, via an automated system 109, through the different processing units 203. In some aspects, the base is a fabric that has not been nanospun. In some aspects, the automated system 109 is configured to convey the base 202 through one or more processing units 203 of the processing system 100. In other aspects, the base 202 is removed from the finished fabric product. In some aspects, each processing unit 203 in system 200 includes one or more spinnerets for applying a specific type of nanofiber sprayable material. In alternative aspects, each processing unit 203 in system 200 includes one or more spinnerets for applying one or more different types of nanofiber sprayable material. In the example illustrated in FIG. 2, the first processing unit #1 applies a first type of nanofiber with desired structural properties to the base layer to form a first nanospun fabric. In this example, the second processing unit #2 applies a second type of nanofiber with desired insulation properties to the first nanospun fabric to form a dual layer substrate that includes a first nanospun fabric attached to a second nanospun fabric. No adhesive is necessary to adhere the two different layers of nanospun fabric together. Next in this example, the third processing unit #3 applies a third type of nanofiber with desired softness properties to the dual layer substrate to from a complex fabric that includes a first nanospun fabric attached to a second nanospun fabric and a third nanospun fabric attached to the second nanospun fabric. No attachment mechanism is necessary to adhere any of the different layers of nanospun fabric together.

An example of the type of nanospun material may include polypropylene, polyethylene, thermoplastic polyurethane, etc. In other aspects, the same nanospun material is utilized in each different processing unit, but the process of how the nanofibers is formed is changed to create different types of nanofiber fabric from the same material. For example, the size or structure of the nanofiber may be adjusted by controlling size, flow, die, and temperature utilized to create the nanofibers from the material. In other aspects, the nanofiber may be shaped or patterned differently, which is described in more detail below.

The first fabric or material 204 is a nanofiber fabric that is sprayed on to the base 202 as the base material rolls through processing unit #1. Next, the base 202 coated with the first material 204 is rolled though a second processing unit 2 where a second fabric or material 206 is added via nanofiber spraying. Finally, in this example, the base 202 coated with the first material 204 and the second material 206 is rolled though a third processing unit 3 where a third material 208 is added via nanofiber spraying. This automated process produces a multilayer substrate 210 that does not utilize any type of adhesive mechanism to combine the different materials.

The materials 204, 206, and 208 are exemplary only and are not meant to be limiting. The multiple pass application system 200 may include processing units for spraying nanofiber materials of any desired type with any desired properties, such as waterproof, wicking, and breathability properties. Additionally, the multiple pass application system 200 may include two, three, four, five, or any desired number of processing units 203 for applying different types of sprayable nanofiber materials. Further, the multiple pass application system 200 may selectively decide not to utilize one or more of the processing units 203 for any given base 202 as desired. As such, the multiple pass application system 200 is customizable and scalable to produce several different types of multilayer substrates utilizing the same system 200. Additionally, the multiple pass application system 200 may include additional treatment features, such as an embossing unit.

FIG. 3. illustrates an example of a single pass application system 300 for automated creation of a multilayer or structured substrate 210. The single pass application system 300 of the processing system 100 utilizes a single processing unit 203. Further, a multilayer substrate 210 formed by system 300 does not utilizing any adhesive mechanism to combine or join the different layers of the same or different types of material together. In this example, the single pass application system 300 includes only a single processing unit 203 for adding more than one type of nanospun fabric to a base 202 as the base 202 rolls, via an automated system 109, through the processing units 203. The processing unit 203 includes a plurality of spinnerets. Each spinnerets 108A, 108B, and 108C applies a different type of nanofiber sprayable material. In this example, the first spinneret 108A applies a first type of material with desired structural properties. In this example, the second spinneret 108B applies a second type of material with desired insulation properties. Also in this example, the third spinneret 108C applies a third type of material with desired softness properties. In alternative aspects, each of the spinnerets 108A, 108B, and 108C apply each of the three different kinds of material. In these aspects, the spinnerets 108A, 108B, and 108C are selectively connected to each of the different types of sprayable nanofibers and switch between the three different fibers as desired. In these aspects, the first sprayable material is applied with spinnerets 108A, 108B, and 108C with desired structural properties and then the second sprayable material with desired insulation properties is applied by the same spinnerets 108A, 108B, and 108C after they switch to a new material source. Also in these aspects, the third material with desired softness properties is applied via spinnerets 108A, 108B, and 108C after the spinnerets switch to another material source. In an alternative aspect, the same material is utilized in each of the spinnerets but formed into different types nanospun fabric by controlling size, flow, die, and temperature utilized to create the nanofibers from the material.

The materials discussed above are exemplary only and are not meant to be limiting. The single pass application system 300 may include any number of spinnerets for spraying nanofiber materials of any desired type with any desired properties, such as waterproof, wicking, and breathability properties. Additionally, the single pass application system 300 may apply any desired number of layers of the same or different types of sprayable nanofiber materials. Further, the single pass application system 300 may selectively decide not to utilize one or more of the sprayable nanofiber materials connected to the spinnerets for any given base 202 as desired. As such, the single pass application system 300 is customizable and scalable to produce several different types of multilayer substrates 210 utilizing the same system 300.

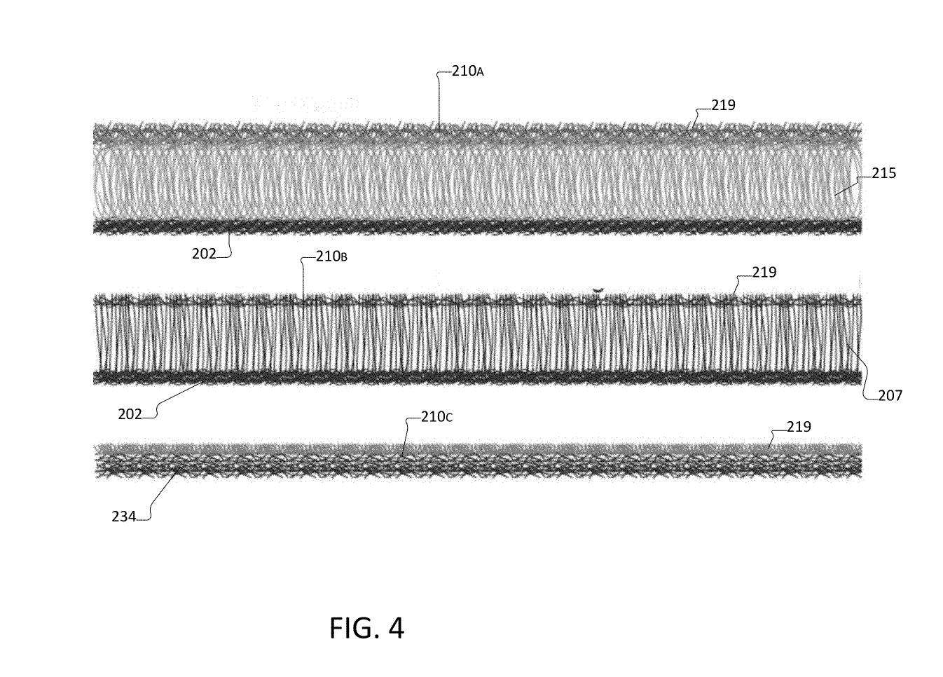

FIG. 4 illustrates different examples of multilayer substrates 210 that may be created by processing system 100. For example, the multilayer substrate 210A includes a base 202, an intermediate insulation layer 215, and a soft material layer 219 as illustrated by FIG. 4. In another example, the multilayer substrate 210B includes a base 202, an intermediate flocked wicking layer 207, and a soft material layer 219 as illustrate by FIG. 4. In yet another example, the multilayer substrate 210C includes a structure material 234 and a soft material layer 219 as illustrate by FIG. 4. These different types of multilayer substrates may be created by the same processing system 100. The different multilayered substrates discussed above are exemplary and are not meant to be limiting. As understood by a person of skill in the art, the multilayer substrate 210 may include any number of material layers with any desired material capable of being sprayed as a nanofiber.

In further aspects, the processing system 100 may be utilized to create a substrate or garment with a unique structure. The unique structure may be applied to the entire substrate or garment or may be applied to one or more layers within the garment or substrate. In other aspects, the unique structure may be applied to one or more portions of garment, such as a sleeve, shoulder or collar portion of a garment. When the nanofibers are sprayed onto a flat surface, the nanofibers form a flat material. However, when the nanofibers are sprayed onto a non-flat surface the nanofibers take the same of the application surface. In other aspects, a nanofiber material may be embossed with different shapes or patterns.

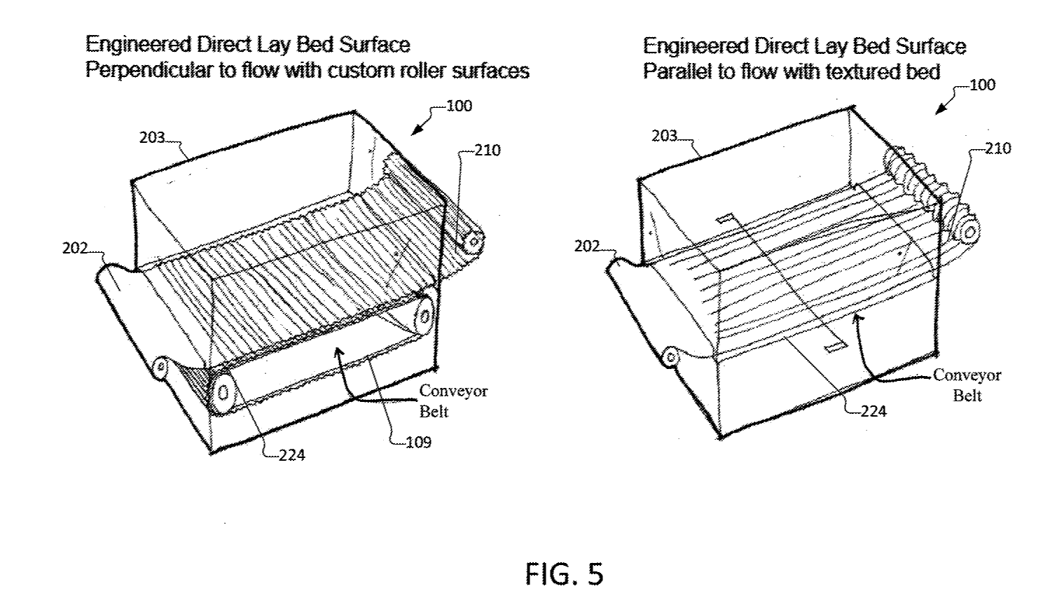

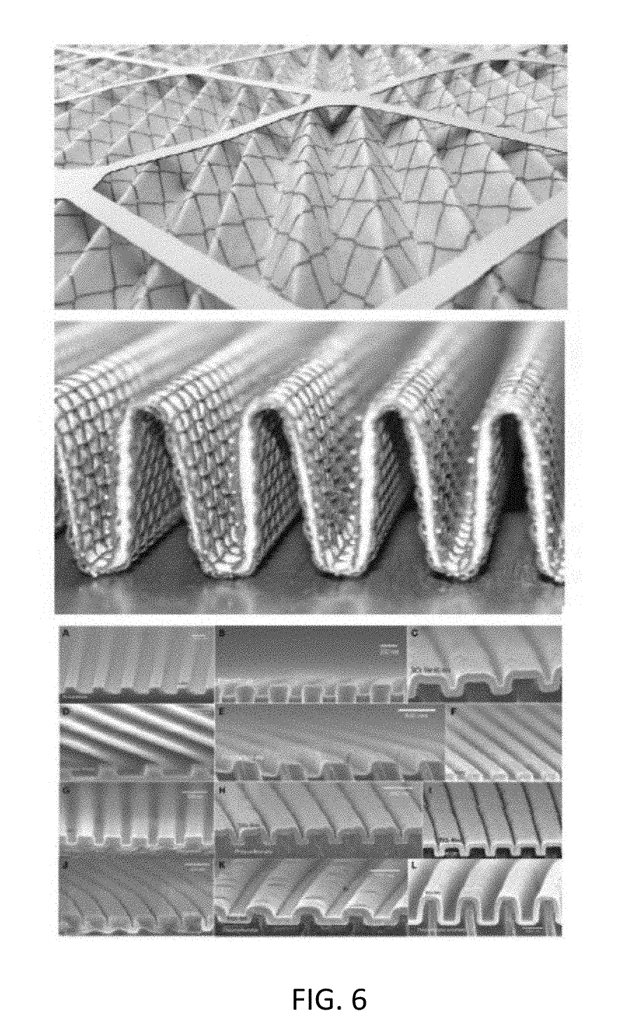

As such, in some aspects, the base 202 may be a custom roll surface 224 that provides a desired structure for any applied sprayable nanofibers. Alternatively, the base 202 may be a base fabric laid upon a custom roll surface 224. The custom roll surface 224 is engineered to have a desired shape. The sprayable nanofibers applied to the custom roll surface 224 and/or base 202 will be formed in the shape of the custom roll surface 224 as illustrated by FIG. 5. As such, the sprayable nanofiber material is manipulated by system 100 utilizing the custom roll surface 224 to provide a desired shape to one or more layers of the substrate and/or garment. The custom roll surface 224 may provide different desired shapes or structures for the sprayable material on the nano, micro, or macro level as illustrated by the size of the shapes provided in FIG. 6. Further, the shapes and structures provided by the custom roll surface 224 may change the qualities of the sprayed nanofiber material. For example, some shapes or structures may change breathability, insulation, airflow, and/or stretch of a given material.

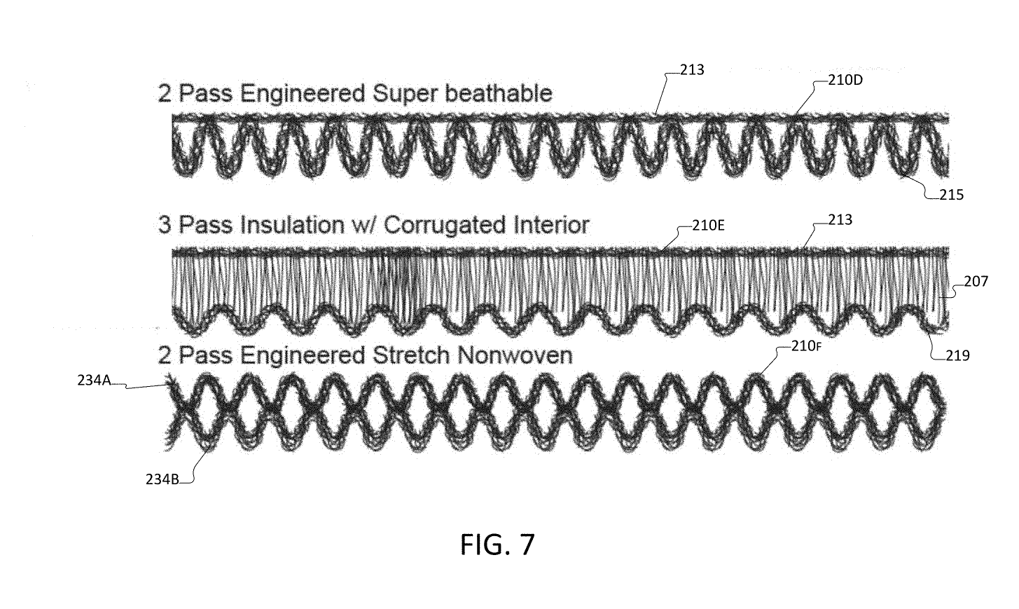

FIG. 7 illustrates different examples multilayer substrates 210 that include desired layer structures created by utilizing a custom roll surface 224 in processing system 100. For example, the multilayer substrate 210D includes a base 213 of a non-nanospun fabric, and an insulation material layer 215 in a shape that increases surface area of the insulation material layer 215 as illustrate by FIG. 7. The increased surface area of the insulation material 215 may improve the breathability of the insulation layer 215. In another example, the multilayer substrate 210E includes a base 213 of a non-nanospun fabric, an intermediate flocked fiber layer 207, and a corrugated soft material layer 219 as illustrate by FIG. 7. The corrugated soft layer 219 may provide improved adhesion of the soft layer. In yet another example, the multilayer substrate 210F includes two layers of structured material 234 both shaped in a pleated design as illustrate by FIG. 7. The pleated design of the structure material layers 234A and 234B may increase the stretch of the structured material layers 234. The different types of multilayer substrates with different layer shapes as discussed above are exemplary and are not meant to be limiting. As understood by a person of skill in the art, the multilayer substrate 210 may include any number of material layers with any desired materials and structures/shapes capable of being formed via a sprayable nanofiber.

In other aspects, as discussed above, a nanofiber fabric may be embossed into different shapes and/or patterns. For example, the nanofiber material may be embossed with a sonic and/or heat roller. The different textures may create warmth, water shedding, stretch, hydrodynamics, aerodynamics, structure, and design aesthetics. As such, heat embossing may be utilized to change the structure and/or stretch dynamics of finished fabrics. In other aspects, heat embossing may be utilized to control the flow of water on a garment, such that water scatters at the bottom rim of the jacket instead of falling straight down. Additionally, certain areas within the embossed pattern may have different properties. For example, portions of the embossed nanofabric may be pressed together more tightly creating areas of waterproofness, water resistance, increased structure and/or reduced breathability within the embossed pattern.

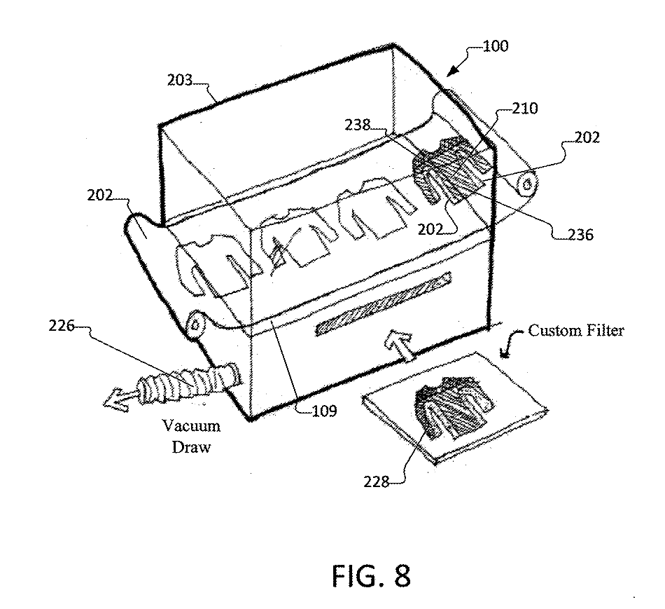

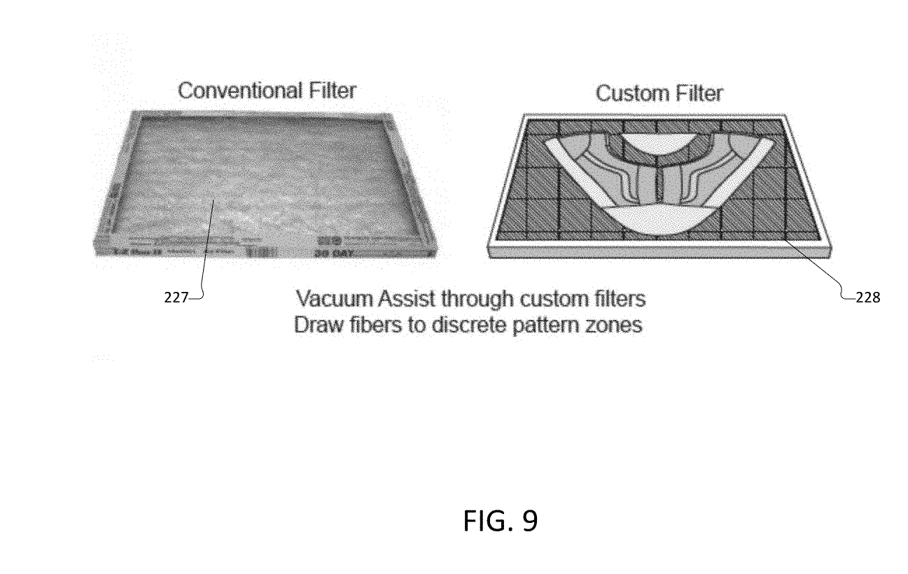

In some aspects, the processing system 100 utilizes custom filters to direct the sprayable nanofiber material to specific areas of a given base 202 or partially treated substrate, garment, or garment portion. In these aspects, the processing unit 203 directs a sprayable nanofiber material to a specific portion of the garment utilizing electrostatic zones or a discreet vacuum and a customizable filter 228. The filter and the vacuum or the electrostatic zone direct sprayable nanofiber material to a specific portion of the base 202 or partially treated substrate, garment, or garment portion. For example, FIG. 8 illustrates an example of a custom filter 228 and a discrete vacuum 226 that directs a first nanosprayable material 238 to the shoulder area of a partial garment and a second nanosprayable material 236 to a front torso and exterior arm region on the partial garment. Further, the created multilayer garment 210, as illustrated in FIG. 8 has only the base material on a side region and interior arm region. As such, the processing system 100 is capable of applying different layers of nanosprayable fabric to specific areas of a base utilizing a customizable filter 228. The custom filter 228 as illustrated in FIG. 9 has different zone for different airflow or electrostatic charge to direct the nanosprayable fabric to a specific region when in a given processing unit 203. The filter may be customizable to mimic a desired garment portion shape and to highlight or change airflow around specific regions of the shaped garment on the filter.

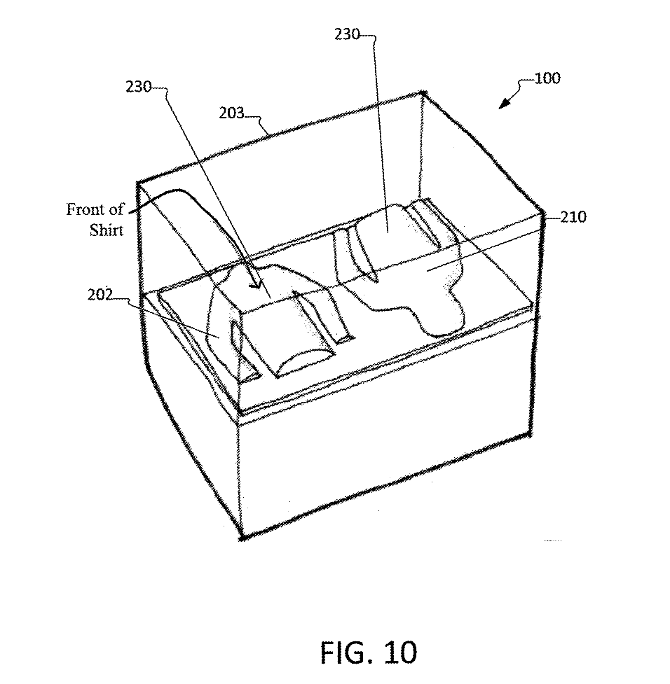

As discussed above, the sprayable nanofiber material may form the shape of whatever the material is spayed upon. As such, in some aspects, the base 202 may be a partial three-dimensional mold of a desired garment or a base material may be laid over the partial three-dimensional mold of the desired garment in a processing unit 203. FIG. 10 illustrates an example of two different partial three-dimensional molds that may be combined to form a jacket. In this example, one or more sprayable nanofibers materials are applied to the two different partial three-dimensional molds as the molds 230 and/or a base 202 move through the processing unit 203. In some aspects, the partial-three dimensional molds have to be manually added or removed from a processing unit 203. These molds allow a structured garment to be formed from the sprayable nanofiber material and have only two or very limited seams. Previously, a structure garment such as jacket would require the combination of several different pieces of material that would increase costs and slow down manufacturing of the jacket.

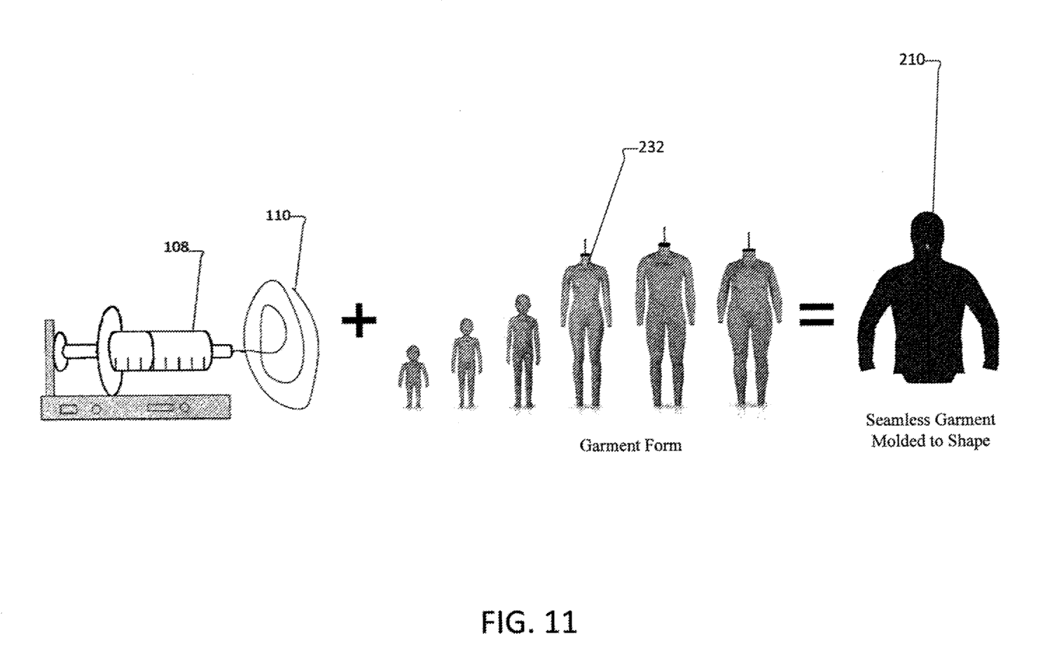

In other aspects, the base 202 may be a three-dimension mold 232. The three-dimensional mold 232 will provide the whole shape of the desired end garment. As such, the garment or multilayered substrate 210 formed utilizing a three-dimension mold 232 in the processing system 100 may have no seams. In these aspects, the automated system 109 may convey the three dimension molds through one or more processing units 203. In some aspects, the automated system 109 may rotate or move the three-dimension mold 232 as the mold 232 is conveyed through one or more processing units 203. In additional aspects, the automated system 109 may rotate or move the spinnerets 108 in each processing unit 203 utilized by processing system 100. FIG. 11 illustrate an example of a rotatable spinneret 108, different three-dimensional molds 232, and a seamless multilayered structure garment 210 that may be formed by a processing system 100 utilizing the three-dimensional molds 232. In this aspect, the jacket is seamless and is formed by cutting the multilayered material to add a zipper and hole for the hood. While the examples provided above, are utilized to form multilayered substrates or garments, the partial three-dimensional molds and the three-dimensional molds may be utilized to form a single layer garment or substrate. Further, the surface of the partial three-dimensional molds and/or the three-dimensional molds may not be smooth and instead include a custom roll surfaces to affect the shape of the nanofiber layers applied to the different molds.

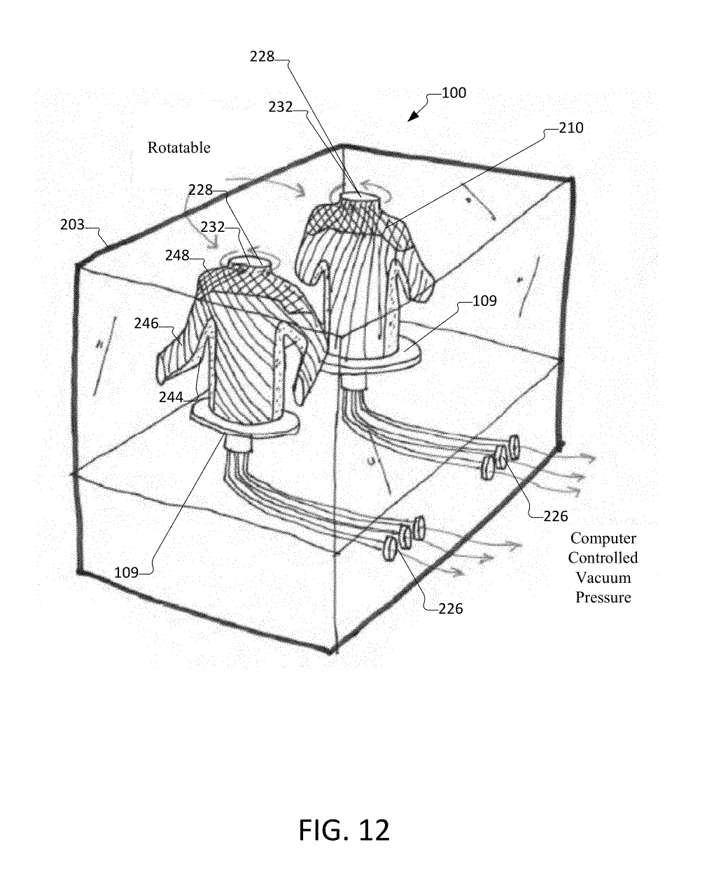

In further aspects, the custom filters 228 and discrete vacuum or electrostatic zone utilized to direct the sprayable nanofiber materials to specific areas may be applied to the partial three-dimensional molds 230 and/or to the three-dimensional molds 232. FIG. 12 illustrates an example of a processing unit 203 after applying a sprayable nanofiber material 248 to a specific portion (upper shoulder region) of a partially treated substrate on a three-dimensional mold 232 utilizing a custom filter 228 on the mold 232 with a vacuum 226. The multilayered garment 210 produced from processing unit 203 includes three different materials (244, 246, and 248) applied in a region specific manner with a desired structure that has no seams and requires no adhesives to join the different materials together. In some aspects, another layer of sprayable nanofiber material may be added on top of all three different material currently shown in FIG. 12 in the processing unit 203 shown in FIG. 12 or in an additional processing unit 203 not displayed in the FIG. 12. The processing system 100 may include an automated system 109 for applying the different nanofiber sprayable materials to the molds 232 or may be only partially automated.

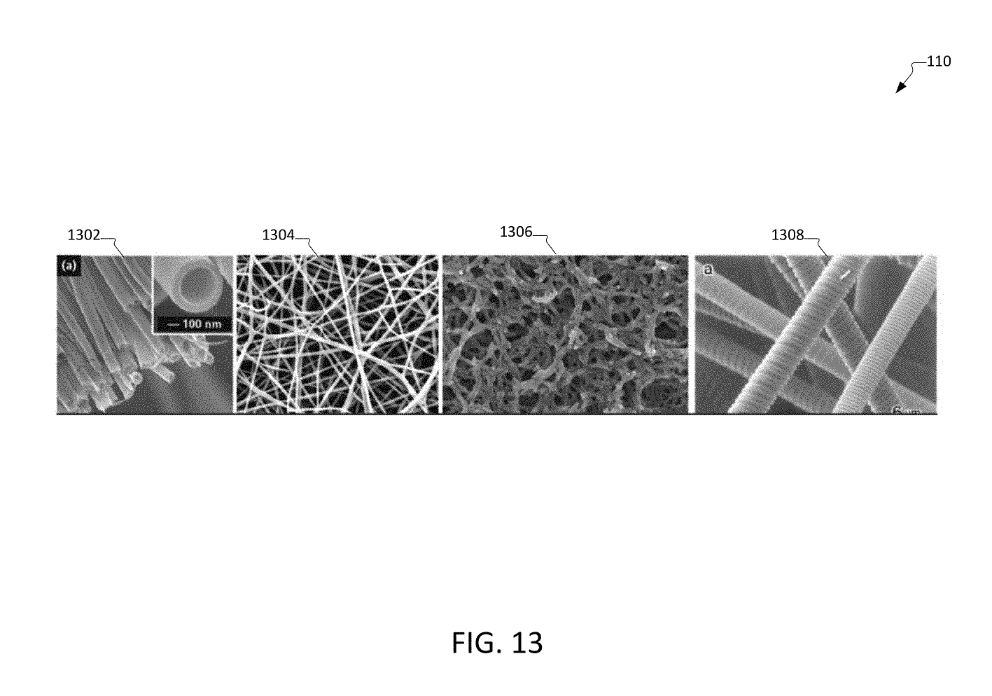

In additional aspects, the nanofibers 110 of the material sprayed are custom shaped to provide desirable properties to the utilized materials. For example, FIG. 13 illustrates different nanofiber shapes or structures that may be formed from the same material by adjusting the application speed, application temperature, and extrusion die utilized by the spinneret and/or spun nanofiber technology of the application system. For example, the nanofibers 110 may be hollow, tapered, barbed, bent, or kinked. This list is exemplary only. Each of these different shapes may affect the properties differently of a given material. For example, the hollow tubed nanofiber 1302 illustrated in FIG. 13 may provide better insulating or wicking properties than the long thin wire nanofibers 1304 also illustrated in FIG. 13. In another example as illustrated by FIG. 13, the ribbed nanofibers 1308 may provide more stretch than the nanofiber structure 1306 for the same material.

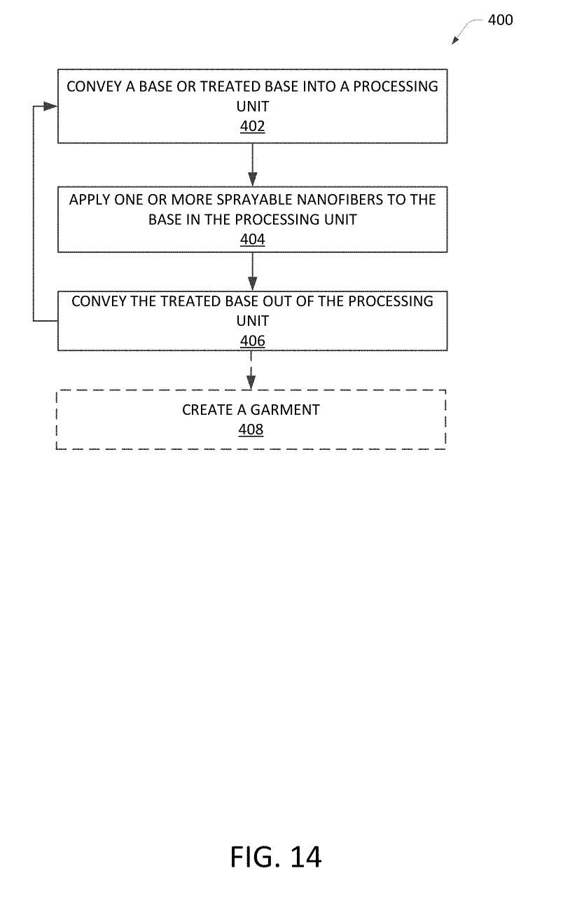

FIG. 14 is a flow diagram illustrating a method 400 for forming a substrate, in accordance with an aspect of the disclosure. In some aspects, method 400 is performed by processing system 100.

Method 400 includes operation 402. At operation 402, a base is conveyed into a processing unit. The base may be fabric, a material, a mold, a custom roll surface, a partial three-dimensional mold and/or a three-dimensional mold. In some aspects, the base is conveyed utilizing an automatic or partially automatic system at operation 402. In other aspects, the base is manually conveyed at operation 402.

Next, method 400 includes operation 404. At operation 404, one or more sprayable nanofibers are applied to the base in the processing unit to form a nanospun fabric. In some aspects, the sprayable nanofibers are created utilizing spun nanofiber technology, such as force spinning, electrospinning, melt electrospinning, centrifugal melt electrospinning, hot air assisted melt electrospinning, island-of-the-sea extrusion and hydrolysis, etc. In some aspects, the processing unit utilizes a custom filter and a vacuum or electrostatic zones to direct the spraying of the nanofibers to specific areas of the base during operation 404. Additionally, a specific nanofiber structure, such as hollow, tapered, barbed, bent, kinked, etc., may be selected and created at operation 404. Further, the processing unit may provide a custom roll surface under the base material to create desired structures in one or more layers of the sprayable nanofibers at operation 404. In other aspects, the created nanospun fabric may be embossed to create a desired structure or pattern on the nanospun fabric.

At operation 406, the treated base is conveyed out of the processing unit. At operation 406, the conveying may be automated or partially automated. In other aspects, the conveying is performed manually at operation 406. In some aspects, after operation 406 the treated base material is treated in another processing unit and operations 402, 404 and 406 are performed again utilizing the treated base material instead of just the base material. In further aspects, operations 402, 404, and 406 may be performed as many times as desired. In other aspects, method 400 ends after operation 406. In these aspects, nanospun fabric material or a compound fabric or material including a nanospun fabric layer is formed. The created material may or may not include the base. If the based is not include, the base is removed from the created material at operation 406 or just after operation 406. In alternative aspects, operation 408 is performed after operation 406.

In some aspects, method 400 includes operation 408. At operation 408, a garment is created from a substrate received from operation 406. The substrate or garment from operations 406 or 408 may include multilayers, multiple materials, and/or none or very limited seams. Further, the garment or substrate from operations 406 or 408 does not include any adhesive mechanisms for attached multiple layers together. At operation 408, the garment may be created by cutting and sewing the created fabric or by adding finishing details such as a zipper, a tag, buttons, etc. depending upon the nanospun technology utilized.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some aspects of the present technology with reference to the accompanying drawings, in which only some of the possible aspects were described. Other aspects can, however, be embodied in many different forms and the specific aspects disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, the various aspects disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

Various embodiments and/or examples are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The embodiments, examples, and details provided in this application are considered sufficient to convey possession and enable others to make and use the best mode of claimed disclosure. The claims should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claims.

What is claimed is:

1. A processing system for producing a multilayer substrate, the processing system comprising:
an application system;
an automated system for conveying a base from an initial position through the application system; and
at least one nanofiber spinneret in the application system configured to spray nanofibers of at least one type of material on to the base located in the application system to form a nonwoven fabric on the base,
wherein the automated system is configured to convey the nonwoven fabric on the base created by the application system to an end position.

2. The processing system of claim 1, wherein the application system includes multiple processing units, wherein the at least one nanofiber spinneret includes a plurality of spinnerets, wherein each processing unit includes one or more spinnerets from the plurality of spinnerets, wherein at least one of the multiple processing units sprays two different types of nanofiber material.

3. The processing system of claim 1, wherein the application system includes multiple processing units, wherein the at least one nanofiber spinneret includes a plurality of spinnerets, wherein each processing unit includes at least one spinneret of the plurality of spinnerets, wherein each processing unit is configured to spray a different type of nanofiber material.

4. The processing system of claim 1, wherein the at least one nanofiber spinneret is configured to spray nanofibers of different types of material by switching from a first material supply stream to a second material supply stream.

5. The processing system of claim 1, wherein the base is a fabric.

6. The processing system of claim 5, wherein the initial position is on a start roll and the end position is on an end roll.

7. The processing system of claim 5, wherein the base material rests on a structured roll surface in the application system.

8. The processing system of claim 5, wherein the base material rests on a partial three-dimensional mold in the application system.

9. The processing system of claim 1, wherein the base is a structured roll surface.

10. The processing system of claim 1, wherein the base is a partial three-dimensional mold.

11. The processing system of claim 1, wherein the base is a three-dimensional mold, and
wherein the application system includes a filter and a vacuum.

12. The processing system of claim 1, wherein the multilayer substrate is for one of: a pair of pants; a shirt; a skirt; a jacket; a pair of shorts; a vest; a hat; a pair of gloves; a dress; a pair of leggings; a pair of capris; a bra; a piece of underwear; a piece of swim wear; and a pair of shoes.

13. The processing system of claim 1, further comprising a heated embossing roller in the application system that is rolled over the nonwoven fabric to create a desired structure or pattern in at least a portion of the nonwoven fabric.

14. A method for creating a garment, the method comprising:
conveying a base into a first processing unit;
applying at least one type of sprayable nanofibers to the base to form a first nanofiber fabric on the base; and
conveying the first nanofiber fabric out of the first processing unit.

15. The method of claim 14, further comprising:
conveying the first nanofiber fabric on the base into a second processing unit;
applying another type of sprayable nanofibers to the first nanofiber fabric to form a multilayered fabric; and
forming the garment from the multilayered fabric.

16. The method of claim 14, wherein the base is a partial three-dimensional mold or a three-dimensional mold, and
wherein the first processing unit utilizes a custom filter and a vacuum to direct the spraying of the at least one type of sprayable nanofibers on to a specific area of the base.

17. The method of claim 14, wherein the first processing unit includes a custom roll surface located underneath a fabric base, and
wherein applying the at least one type of sprayable nanofibers to the base comprises:
creating a specific nanofiber structure.

18. A garment, the garment comprising:
a first layer, wherein the first layer is formed utilizing sprayed first nanofibers;
a second layer attached to the first layer, wherein the second layer is formed utilizing sprayed second nanofibers,
wherein no seams are on the garment,
wherein an attachment mechanism is not utilized to attach the first layer to the second layer, and
wherein the first layer has a different structure than the second layer.

19. The garment of claim 18, wherein the first nanofibers in the first layer have a different structure than the second nanofibers in the second layer

20. The garment of claim 18, wherein the first layer is a different material than the second layer.
